(19) United States
(12) Patent Application Publication
(10) Pub. No.: US 2026/0274094 A1
(43) Pub. Date: Sep. 17, 2026

(54) Non-Fluid Cooled Electric Vehicle Fast-Charge Cable

(71) Applicant: RSCC Wire & Cable LLC, East Granby, CT (US)

(72) Inventors: Gil SHOSHANI, Wallingford, CT (US); Phil LAUDICINA, The Woodlands, TX (US); Altin DABULLA, Naples, FL (US)

(73) Assignee: RSCC Wire & Cable LLC, East Granby, CT (US)

(21) Appl. No.: 19/679,613

(22) Filed: May 15, 2026

Related U.S. Application Data
(62) Division of application No. 17/588,029, filed on Jan. 28, 2022, now abandoned.
(60) Provisional application No. 63/143,146, filed on Jan. 29, 2021.

(51) Int. Cl. B60L 53/18; B60L 53/16; H01B 7/18; H01B 7/42

(52) U.S. Cl. CPC B60L 53/18; B60L 53/16; H01B 7/1895; H01B 7/421

(57) ABSTRACT

A non-fluid cooled fast-charge electric vehicle (EV) cable includes a pair of cabled insulated conductors, a binder, a thermal layer of a synthetic porous material having extremely low density and extremely low thermal conductivity in a blanket, with a fiberglass cover and a jacket.

### CROSS-REFERENCE TO RELATED APPLICATION

This application is based upon and claims priority to Provisional Application No. 63/143,146 filed on Jan. 29, 2021, the entire content thereof is incorporated herein by reference in its entirety for all purposes.

### BACKGROUND

The present disclosure relates generally to a charging cable for electric vehicles, and more specifically, a non-fluid cooled charging cable for electric vehicles.

Electric vehicles (EVs) operate on battery power stored in on-board batteries. The batteries are recharged using power supplied from a power grid. There are a number of “levels” of charging. Level 1 charging uses standard, e.g., residential electrical power (120V), which can take many hours to fully charge a vehicle's battery. Level 2 charging uses 220-204V and can often be found in residential, retail, and office charging stations. Level 2 charging can fully charge a vehicle over the course of a workday or night. The most efficient charging is Level 3 charging using “fast chargers” that can charge a vehicle to 80% or more in about 30 minutes and fully charge a vehicle in about 60 minutes.

It will, however, be appreciated that fast chargers operate at high power levels that require that the cables between the charging station and the vehicle be cooled. Traditional fast charging systems rely on fluid cooling tubes to cool the cables and connectors (the connectors between the cables and the vehicle) due to the heat generated by the power draw. This allows the cables to be “handled” by individuals during charging.

Accordingly, there is a need for a fast charge cable that does not require fluid to maintain the cables and connectors cool to allow handling the cable.

### SUMMARY

According to an embodiment, a fast-charge EV cable requires no cooling coils or fluid. In an embodiment, the cable includes an insulated conductor, a binder, a thermal layer, and a jacket positioned around the thermal layer. In an embodiment, the thermal layer is a synthetic porous material having extremely low density and extremely low thermal conductivity. One suitable thermal layer is a thermal blanket, formed as a blanket having an outer layer and an aerogel material. The outer layer can be, for example, a fiberglass material.

In an embodiment, the cable includes two insulated conductors and the conductors can be cabled. The cable can include more than two insulated conductors.

In some embodiments, the binder is positioned around the cabled conductors, the thermal layer is positioned around the binder, and the jacket is positioned around the thermal layer. The binder can be a mica-based material such as a mica tape. The tape can be applied over the conductors in an overlap. One suitable overlap is a 25 percent overlap. The jacket can be an abrasion and cut resistant material, such as a polymeric material, such as a thermoplastic polyurethane material. In one or more embodiments, the jacket has a nominal wall thickness of about 0.120 inches. Other suitable jacket materials include, for example, thermoset materials. Other suitable jacket thicknesses, as well as materials, will be appreciated by those skilled in the art.

In embodiments, the conductors are flexible, tinned, extruded copper conductors. The conductors can be, for example, 2/0 AWG, flexible, tinned, extruded copper class K conductors. In other embodiments, the conductors are 4/0 AWG flexible, tinned, extruded copper class K conductors. An example of a 2/0 AWG conductor is a 1323/30 stranding conductor; an example of a 4/0 AWG conductor is a 1995/30 stranding conductor. Other gauge suitable conductors will be recognized by those skilled in the art.

In one or more embodiments, the cable includes two insulated conductors, each conductor including a thermal layer positioned around the insulated conductors and the conductors with the thermal layers are cabled to form an assembly with the binder positioned around the assembly, and the jacket positioned around the binder.

In one or more embodiments, the cable includes two insulated conductors, each conductor including a thermal layer positioned around the insulated conductors with the conductors and thermal layers cabled to form an assembly. In such embodiments, the binder is positioned around the assembly, a further thermal layer is positioned around the binder, and the jacket is positioned around the further thermal layer.

In another embodiment, the cable includes an insulated conductor, an air channel, and a jacket. The insulated conductor may include an insulator surrounding a conductor. The air channel may provide airflow that may transfer heat away from the insulated conductor. The jacket may surround the insulated conductor and air channel.

In an embodiment, the cable includes a silicon spacer. The silicon spacer may be adjacent to the insulated conductor.

In an embodiment, the conductor may include two conductors, and the two conductors may include silicon surrounding and coupling the two conductors.

In an embodiment, the conductor may include at least one gap that may include the air channel.

In an embodiment, the insulator may include at least one gap that may include an air channel.

In an embodiment, the cable may include at least one air tube, at least one air tube may be located adjacent to the insulated conductor, and may include the air channel.

In an embodiment, at least one air tube may include an aluminum air tube.

In an embodiment, the insulated conductor and the at least one air tube may be cabled.

In an embodiment, at least one air tube may include airflow in one direction.

In an embodiment, at least one air tube may include a first air tube and a second air tube. The first air tube and second air tube may include air flow in opposite directions.

These and other features and advantages of the present invention will be apparent from the following detailed description, in conjunction with the appended claims.

### BRIEF DESCRIPTION OF THE DRAWINGS

FIG. 1 is a cross-sectional diagram of an embodiment of a fast charge according to the present disclosure.

FIG. 2 is a cross-sectional diagram of another embodiment of a fast charge cable.

FIG. 3 is a cross-sectional diagram of still another embodiment of a fast charge cable.

FIG. 4 is a cross-sectional diagram of still another embodiment of a fast charge cable.

FIG. 5 is a cross-sectional diagram of still another embodiment of a fast charge cable.

FIG. 6 is a cross-sectional diagram of still another embodiment of a fast charge cable.

FIG. 7 is a cross-sectional side view of the fast charge cable of FIG. 4.

FIG. 8 is a cross-sectional side view of the fast charge cable of FIG. 5.

FIG. 9 is a cross-sectional side view of the fast charge cable of FIG. 6.

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

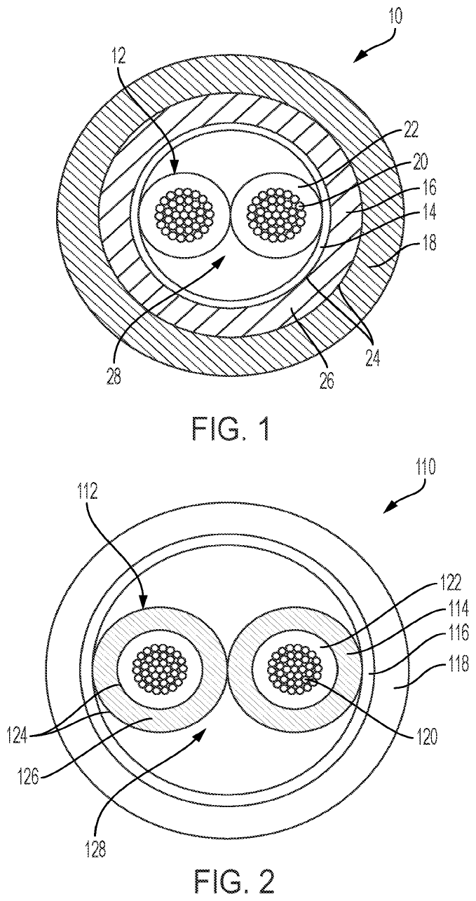

FIG. 1 is a cross-sectional diagram of an embodiment of a non-fluid cooled electric vehicle (EV) fast-charge cable 10 for electric vehicles. Cable 10 includes an insulated conductor 12, a binder 14, a thermal layer 16, and a jacket 18. In the illustrated embodiment, the insulated conductor 12 includes a conductor 20, such as a flexible, tinned extruded copper conductor, such as a 2/0 AWG tinned copper class K conductor. One suitable flexible, tinned extruded copper conductor is a 2/0 AWG (1323/30 stranding) conductor. Insulation 22 is present on conductor 20. An insulation such as a thermoset heat resistant material, such as a silicone rubber insulation having, for example, a minimum average wall of 0.080 inches. In an embodiment, two insulated conductors 12 are used. The insulated conductors 12 are cabled (twisted) with a left-hand lay. Cable 10 may include more than two insulated conductors 12.

The binder 14 is positioned around the insulated conductors 12. In an embodiment, binder 14 is a tape, such as a mica tape. One suitable mica tape is a 0.005-inch thick mica tape. The tape may be applied in an overlap. One suitable overlap is a 25 percent overlap.

The thermal layer 16 is positioned around the binder tape 14. A suitable thermal layer 16 is a thermal blanket or bedding and includes a solid with extremely low density and extremely low thermal conductivity, such as an aerogel-based thermal blanket in which a fiberglass material 24 encases the aerogel material 26. The aerogel material 26 is a synthetic porous ultralight material derived from a gel, in which the liquid component for the gel has been replaced with a gas without significant collapse of the gel structure. In an embodiment, the thermal layer blanket 16 has a nominal wall thickness of about 0.300 inches.

Jacket 18 is positioned around the thermal blanket 16. Jacket 18 can be, for example, an abrasion and cut resistant material, such as a polymeric material, such as thermoplastic polyurethane (TPU) material. Other suitable jacket materials include thermoset materials. One current jacket 18 is a TPU material having a nominal wall thickness of about 0.120 inches.

A current EV cable 10 construction has two insulated conductors 12 in which the conductors 20 (bare) have a nominal diameter of about 0.48 inches and the insulation 22 has a minimum average wall of 0.080 inches. The two insulated conductors 12, again cabled with a left-hand lay, form an assembly 28, having a nominal diameter of about 1.288 inches. The assembly 28 with the binder tape 14 applied in an overlap, such as a 25 percent overlap, has a nominal diameter of about 1.301 inches. With the thermal blanket 16, the nominal diameter is about 1.908 inches, and with jacket 18 positioned over the thermal blanket 16, which forms the EV cable 10, the nominal diameter is about 2.155 inches.

FIG. 2 illustrates an alternate embodiment of an EV cable 110. In this embodiment, cable 110 includes an insulated conductor 112, a thermal layer 114, a binder 116, and a jacket 118. In the illustrated embodiment, the insulated conductor 112 includes a conductor 120, such as a 4/0 AWG (1995/30 stranding) tinned copper class K conductor. Insulation 122 is present on the conductor 120, such as a thermoset heat resistant material, such as silicone rubber insulation having a minimum average wall of 0.080 inches.

The thermal layer 114 is positioned around the insulated conductor 112. A suitable thermal layer 114 is a thermal blanket or bedding formed from a solid with extremely low density and extremely low thermal conductivity, such as an aerogel-based thermal blanket in which a fiberglass material 124 encases the aerogel material 126. The aerogel material 126 is a synthetic porous ultralight material derived from a gel, in which the liquid component for the gel has been replaced with gas without significant collapse of the gel structure. In an embodiment, the thermal layer blanket 114 has a nominal wall thickness of about 0.300 inches.

In the illustrated embodiment, two insulated conductors 112 with individual thermal layers 114 are used, the conductors 112 with the thermal layers 114 are cabled (twisted) with a left-hand lay. The two conductors 112 with the thermal layers 114 define an assembly 128.

The binder 116 is positioned around assembly 128 (the conductors 112 with the thermal layers 114). In an embodiment, the binder 116 is a tape, such as a mica tape. One suitable mica tape is a 0.005-inch thick mica tape. The tape may be applied in an overlap, such as a 25 percent overlap.

Jacket 118 is positioned around binder 116. The jacket 118 can be, for example, an abrasion and cut resistant material, such as a polymeric material, such as a TPU material having a nominal wall thickness of about 0.120 inches. Other suitable jacket materials include thermoset materials; other suitable jacket thicknesses will be appreciated by those skilled in the art.

The illustrated EV cable 110 construction has two insulated conductors 112 in which the conductors 120 (bare) have a nominal diameter of about 0.549 inches and the insulation 122 has a minimum average wall of 0.080 inches.

In this embodiment, a thermal blanket 114 is positioned around each of the individual insulated conductors 112. The thermal blankets 114 each have a nominal wall thickness of about 0.300 inches, and the insulated conductors 112 with the blankets 114 each have a nominal diameter of about 1.32 inches. The two conductors 112 with their thermal blankets 114 are cabled with a left-hand lay to form the assembly 128 having a nominal diameter of about 2.641 inches, and the binder tape 116 is positioned over the assembly 128 at an overlap, such as a 25 percent overlap with an overall nominal diameter of about 2.649 inches.

The jacket 118, for example, an abrasion and cut resistant material, such as a polymeric material, such as a TPU material jacket 118, is positioned around the binder 116, with the resulting cable 110 having a nominal diameter of about 2.895 inches. Other suitable materials include, for example, thermoset materials; other suitable jacket thicknesses will be appreciated by those skilled in the art.

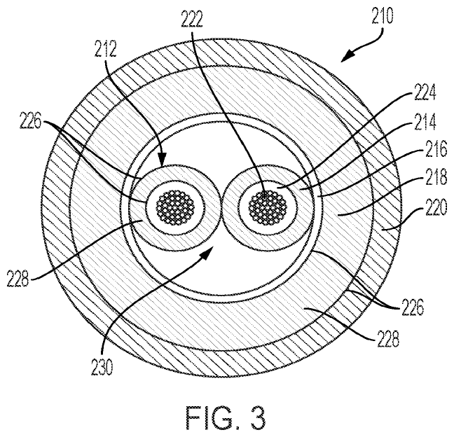

FIG. 3 illustrates still another alternate embodiment of an EV cable 210. In this embodiment, which is similar to the embodiment of FIG. 2, cable 210 includes an insulated conductor 212, a thermal layer 214, a binder 216, another (or additional) thermal layer 218, and a jacket 220. In the illustrated embodiment, the insulated conductor 212 includes a conductor 222, such as a flexible, tinned extruded 4/0 AWG copper class K conductor. One such conductor is a flexible, tinned extruded 4/0 AWG (1995/30 stranding), copper class K conductor. Insulation 224 is present on the conductor 222, such as a thermoset heat resistant material, such as silicone rubber insulation having, for example, a minimum average wall of 0.080 inches.

The thermal layer 214 is positioned around the insulated conductor 212. A suitable thermal layer 214 is a thermal blanket or bedding, such as a solid with extremely low density and extremely low thermal conductivity, such as an aerogel-based thermal blanket in which a fiberglass material 226 encases the aerogel material 228. The aerogel material 228 is a synthetic porous ultralight material derived from a gel, in which the liquid component for the gel has been replaced with a gas without significant collapse of the gel structure. In an embodiment, the thermal layer blanket 214 has a nominal wall thickness of about 0.300 inches.

In the illustrated embodiment, two insulated conductors 212 with individual thermal layers 214 are used. The conductors 212 with the thermal layers 214 are cabled (twisted) with a left-hand lay. The two conductors 212 with their thermal layers 214 define an assembly 230.

The binder 216 is positioned around assembly 230 (the conductors 212 with their thermal layers 214). In an embodiment, the binder 216 is a tape, such as a mica tape. One suitable mica tape is a 0.005-inch thick mica tape. The tape may be applied in an overlap, such as a 25 percent overlap.

The second thermal layer 218 is positioned around assembly 230. The second thermal 218 layer has a nominal wall thickness of about 0.300 inches, and jacket 220 is positioned around the second thermal layer 218. The jacket 220 can be, for example, an abrasion and cut resistant material, such as a polymeric material, such as a TPU material having a nominal wall thickness of about 0.120 inches. Other suitable jacket materials include, for example, thermoset materials; other suitable jacket thicknesses will be appreciated by those skilled in the art.

The illustrated EV cable 210 construction has two insulated conductors 212 in which the conductors 222 (bare) have a nominal diameter of about 0.549 inches and the insulation 224 has a minimum average wall thickness of 0.080 inches.

In this embodiment, thermal blankets 214 are positioned around each of the individual insulated conductors 212. The thermal blankets 214 each have a nominal wall thickness of about 0.300 inches, and the insulated conductors 212 with their blankets each have a nominal diameter of about 1.32 inches. The two conductors 212 with their thermal blankets 214 are cabled with a left-hand lay to form the assembly 230, which has a nominal diameter of about 2.641 inches. The binder tape 216 is positioned over the assembly 230. The binder tape 216 can be positioned over the assembly 230 in an overlap, such as a 25 percent overlap with an overall nominal diameter of about 2.649 inches.

The second thermal blanket 218 is positioned over the binder tape 216 and the assembly 230 with binder tape 216, and second thermal blanket 218 has a nominal diameter of about 3.257 inches. The jacket 220, for example, an abrasion and cut resistant material, such as a polymeric material, such as a TPU material jacket 220, is positioned around the second thermal blanket 218 and the resulting cable 210 has a nominal diameter of about 3.503 inches. Other suitable jacket materials include, for example, thermoset materials; other suitable jacket thicknesses will be appreciated by those skilled in the art.

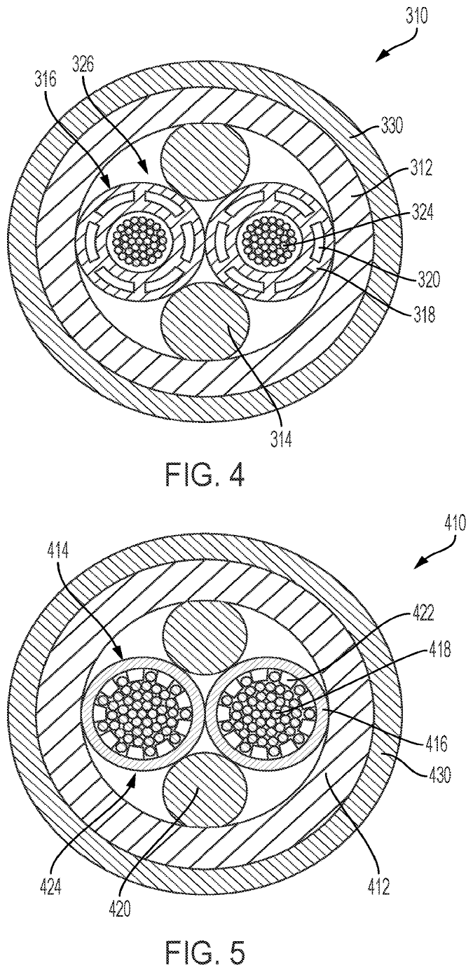

FIG. 4 illustrates still another alternate embodiment of an EV cable 310. In this embodiment, cable 310 includes insulated conductor 316, a silicon spacer 314, a layer 312, and a jacket 330. Layer 312 may include a binder and/or a thermal layer. In the illustrated embodiment, the insulated conductor 316 includes a conductor 324, such as a 4/0 AWG (1995/30 stranding) tinned copper class K conductor. Insulation 318 is present on the conductor 324, such as a thermoset heat resistant material, such as silicone rubber insulation.

Insulation 318 includes at least one gap 320 that defines an air channel. Gap 320 may include multiple gaps that surround the conductor 324 and allow for heat to move from the conductor 324 to and through the gaps 320 while maintaining sufficient structural integrity or strength to prevent the gaps from collapsing under pressure.

Gaps 320 allow air to flow within the insulation 318 and move heat away from the conductor 324 to limit the heat from transferring to layer 312 and jacket 330. The airflow, for example, may move the heat generated in the conductor 324 through cable 310 and out of one end of the cable. For example, air could come into cable 310 at the charging end, the end that connects to the EV and is handled by a user, and the air could flow through cable 310 within gaps 320 and flow out of the other end of cable 310. Thus, moving heat generated from conductor 324 away from the conductor and limiting heat transferring to layer 312 and jacket 330. The heat transfer could, for example, be limited to the air channels, such that little heat is transferred to layer 312 and jacket 330. Furthermore, since air comes in from the charging end of cable 310, the temperature of cable 310 would be lowest at the charging end compared to the outlet end of cable 310.

In the illustrated embodiment, two silicon spacers 314 and two insulated conductors 316 having insulation 318 with gaps 320 are used. The silicon spacers 314 and insulated conductors 316 can be cabled (twisted) with a left-hand lay. The two silicon spacers 314 and two insulated conductors 316 define an assembly 326.

Layer 312 is positioned around the assembly 326 (the conductors 324 with their insulation 318). In an embodiment, the layer includes a binder that is a tape, such as a mica tape. One suitable mica tape is a 0.005-inch thick mica tape. The tape may be applied in an overlap, such as a 25 percent overlap. Layer 312 may also include a thermal blanket that can be positioned around assembly 326. The thermal blanket may have a nominal wall thickness of about 0.300 inches, and jacket 330 is positioned around layer 312. The jacket 330 can be, for example, an abrasion and cut resistant material, such as a polymeric material, such as a TPU material. Other suitable jacket materials include, for example, thermoset materials; other suitable jacket materials will be appreciated by those skilled in the art.

The illustrated EV cable 310 construction has two silicon spacers and two insulated conductors 316 in which the conductors 324 (bare) have a nominal diameter of about 0.549 inches and the insulation 318 has a minimum average wall thickness of 0.080 inches with gaps 320 for airflow.

Silicon spacer 314 includes two silicon spacers positioned within the assembly 326 that provide structural support, which allows insulated conductor 316 space within the assembly 326 and little contact with layer 312. The silicon spacer may have a diameter between 14.6 mm to 16.7 mm.

In an embodiment, cable 310 may have a thickness of 5.21 mm.

In an embodiment, silicon spacer 314 has a diameter of 16.7 mm.

In an embodiment, cable 310 may have a diameter of 75.02 mm.

FIG. 5 illustrates still another alternate embodiment of an EV cable 410. In this embodiment, which is similar to the embodiment of FIG. 4, cable 410 includes insulated conductor 414, a silicon spacer 420, a layer 412, and a jacket 430. Layer 412 may include a binder and/or a thermal layer. In the illustrated embodiment, the insulated conductor 414 includes a conductor 418, such as a 4/0 AWG (1995/30 stranding) tinned copper class K conductor. Insulation 416 is present on the conductor 418, such as a thermoset heat resistant material, such as silicone rubber insulation.

Insulation 416 includes at least one gap 422 that define an air channel. Gap 422 include multiple gaps between individual conductors at the outer edge of conductor 418. Gaps 422 allow for heat to move from the conductor 418 to and through the gaps 422. Gaps 422 allow for a smaller cable 410 diameter as the gaps are within the conductor 418.

Gaps 422 allow air to flow between insulation 416 and conductor 418 and through the cable to limit the transfer of heat to layer 412 and jacket 430. The airflow, for example, may move the heat generated in the conductor 418 through cable 410 and out of one end of the cable. For example, air could come into cable 410 at the charging end, the end that connects to the EV and is handled by a user, and the air could flow through cable 410 within gaps 422 and flow out of the other end of cable 410. Thus, moving heat generated from conductor 418 away from the conductor and limiting heat transferring to layer 412 and jacket 430. The heat transfer could, for example, be limited to the air channels, such that little heat is transferred to layer 412 and jacket 430. Furthermore, since air comes in from the charging end of cable 410, the temperature of cable 410 would be lowest at the charging end compared to the outlet end of cable 410.

In the illustrated embodiment, two silicon spacers 420 and two insulated conductors 418 having insulation 416 with gaps 422 are used. The silicon spacers 420 and insulated conductors 414 are cabled (twisted) with a left-hand lay. The two silicon spacers 420 and two insulated conductors 414 define an assembly 424.

Layer 412 is positioned around assembly 424 (silicon spacers 420 and conductors 418 with their insulation 416). In an embodiment, the layer includes a binder that is a tape, such as a mica tape. One suitable mica tape is a 0.005-inch thick mica tape. The tape may be applied in an overlap, such as a 25 percent overlap. Layer 412 may also include a thermal blanket that can be positioned around the assembly 424. The thermal blanket may have a nominal wall thickness of about 0.300 inches, and the jacket 430 is positioned around layer 412. The jacket 430 can be, for example, an abrasion and cut resistant material, such as a polymeric material, such as a TPU material. Other suitable jacket materials include, for example, thermoset materials; other suitable jacket materials will be appreciated by those skilled in the art.

The illustrated EV cable 410 construction has two silicon spacers and two insulated conductors 414 in which the conductors 418 (bare) have a nominal diameter of about 0.549 inches and the insulation 416 has a minimum average wall thickness of 0.080 inches with gaps 422 for airflow.

Silicon spacer 420 includes two silicon spacers positioned within the assembly 424 that provide structural support, which allows insulated conductor 414 space within the assembly 424 and little contact with layer 412. The silicon spacer may have a diameter between 14.6 mm to 16.7 mm.

In an embodiment, cable 410 may have a thickness of 4.83 mm.

In an embodiment, silicon spacer 420 has a diameter of 14.6 mm.

In an embodiment, cable 410 may have a diameter of 66.21 mm.

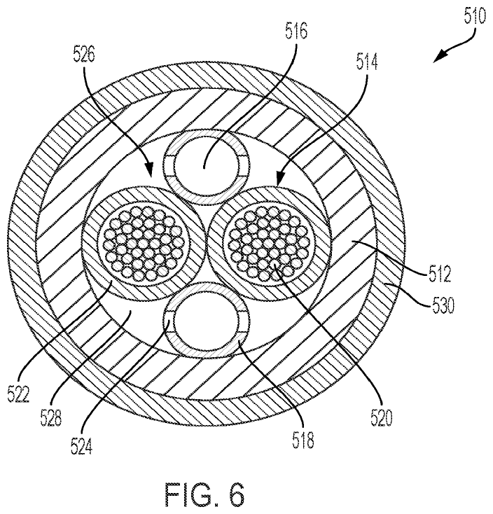

FIG. 6 illustrates still another alternate embodiment of an EV cable 510. In this embodiment, cable 510 includes air tube 518, insulated conductors 514, layer 512, and jacket 530. Layer 512 may include a binder and/or a thermal layer. In the illustrated embodiment, the insulated conductor 514 includes conductor 520, such as a 4/0 AWG (1995/30 stranding) tinned copper class K conductor. Insulation 522 is present on the conductor 520, such as a thermoset heat resistant material, such as silicone rubber insulation. Insulation 522 is positioned within the assembly 526 and provides structural support, which allows insulated conductor 520 space within the assembly 526 and little contact with layer 512.

Air tube 518 includes a tubular structure that defines an air channel 516. Air tube 518 further includes opening 524. Opening 524 allows air to flow in to and out of air tube 518, into a space 528 between insulated conductor 514 and air tube 518. Thus, air may flow through air tube 518 and into the space 528 between the insulated conductor 514 and the air tube 518, allowing for more heat to be transferred from the conductor 520. The air tube 518 may be made out of aluminum.

Air tube 518 allows air to flow away from the insulated conductor 514, through the cable 510, to limit the transfer of heat to layer 512 and jacket 530. The airflow, for example, may move the heat generated in the conductor 520 through cable 510 and out of one end of the cable. For example, air could come into cable 510 at the charging end, the end that connects to the EV and is handled by a user, and the air could flow through cable 510 within air tube 518 and flow out of the other end of cable 510. Thus, moving heat generated from conductor 520 away from the conductor and limiting heat transferring to layer 512 and jacket 530. In another embodiment, air may flow from the charging end of cable 510 through one air tube 518 to the other end of cable 510, where it is routed to a second air tube 518 on cable 510 and flows to the charging end of cable 510. Air tube 518 may be connected to a second air tube 518 in cable 510 using a tubular structure that bends and connects the ends of the air tubes 518. The tubular structure, at the bend, may include a cooling structure to further cool the airflow before being routed into the second air tube. The cooling structure, for example, may be a structure that is partially outside of jacket 530. The partially exposed structure can include a heat sink. In another example, the cooling structure may include a fan that forces chilled air into the tubular structure at the bend.

In an embodiment, air tubes 518 may allow for a smaller cable 510 diameter because there are no gaps or holes in the insulation 522 or conductor 514.

Layer 512 is positioned around assembly 526 (air tubes 518 and conductor 520 with insulation 522). In an embodiment, layer 512 includes a binder that is a tape, such as a mica tape. One suitable mica tape is a 0.005-inch thick mica tape. The tape may be applied in an overlap, such as a 25 percent overlap. Layer 512 may also include a thermal blanket that can be positioned around assembly 526. The thermal blanket may have a nominal wall thickness of about 0.300 inches, and jacket 530 is positioned around layer 512. The jacket 530 can be, for example, an abrasion and cut resistant material, such as a polymeric material, such as a TPU material. Other suitable jacket materials include, for example, thermoset materials; other suitable jacket materials will be appreciated by those skilled in the art.

In an embodiment, cable 510 may have a thickness of 4.32 mm.

In an embodiment, air tube 518 may have a diameter of 12.1 mm.

In an embodiment, cable 510 may have a diameter of 57.92 mm.

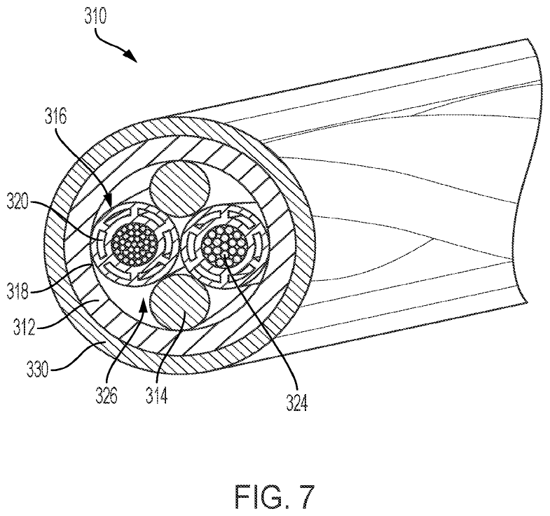

FIG. 7 illustrates a side view of the cable 310 of FIG. 4. Cable 310 includes insulated conductor 316, silicon spacer 314, layer 312, and jacket 330. Insulated conductor 316 includes conductor 324 and insulator 318 with gaps 320. Silicon spacers 314 and insulated conductors 316 are cabled (twisted) with a left-hand lay. Conductor 324 includes individual conductors that are cabled within insulator 318. Conductor 324, in FIG. 7, shows a conductor that is bare for illustrating how it is cabled (twisted).

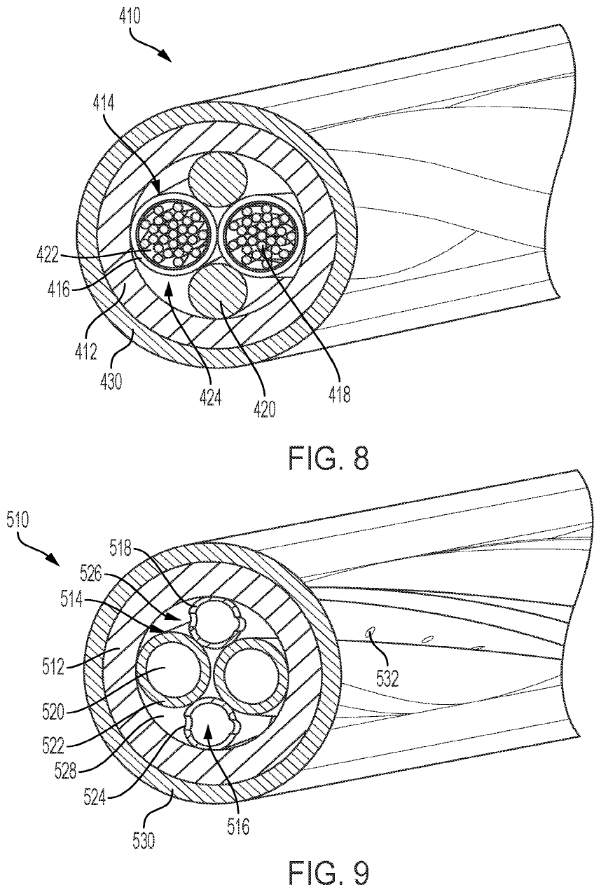

FIG. 8 illustrates a side view of the cable 410 in FIG. 5. Cable 410 includes insulated conductor 414, silicon spacer 420, layer 412, and jacket 430. Insulated conductor 414 includes conductor 418 and insulator 416 with gaps 422. Silicon spacers 420 and insulated conductors 414 are cabled (twisted) with a left-hand lay. Conductor 418 includes individual conductors that are cabled within insulator 416. Conductor 418, in FIG. 8, shows a conductor that is bare for illustrating how it is cabled (twisted).

FIG. 9 illustrates a side view of the cable 510 in FIG. 6. Cable 510 includes air tube 518, insulated conductor 514, layer 512, and jacket 530. Air tube 518 and insulated conductor 514 are cabled (twisted) with a left-hand lay. Conductor 520 may include individual conductors that are cabled within insulator 522. Air tube 518 includes openings 524 and 532 that allow air to flow into and out of assembly 526.

In one or more embodiments, the airflow may be increased using a fan or other device to force the movement of air into or out of the charging cable.

In one or more embodiments, the airflow may include chilled air, forced or natural flowing, into the cable. The chilled air, for example, may flow from the end of the cable that does not plug to the EV.

Those skilled in the art will appreciate the advantages of a fast-charge EV cable that does not require cooling coils, eliminating the cooling fluid, fluid connections, and potential leakage. Although certain materials for the insulation, binder, thermal blanket, and jacket are disclosed, those skilled in the art will recognize the other suitable materials that may be used for the fast-charge EV cable, which other materials are within the scope and spirit of the present disclosure. It will also be recognized that the various materials and layers in any disclosed embodiment may be used with others of the embodiments and that all such embodiments and variations thereof are within the scope and spirit of the present disclosure.

All patents referred to herein are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular. In addition, it is understood that terminology referring to the orientation of various components, such as “upper” or “lower,” is used for the purposes of example only and does not limit the subject matter of the present disclosure to a particular orientation.

From the foregoing, it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as they fall within the scope of the claims.

1-10. (canceled)

11. A cable for fast-charging an electric vehicle (EV), comprising:
an insulated conductor, wherein the insulated conductor comprises an insulator surrounding a conductor;
an air channel, wherein the air channel provides air flow that transfers heat away from the insulated conductor; and
a jacket, wherein the jacket surrounds the insulated conductor and air channel.

12. The cable of claim 11, further comprising:
a silicon spacer, wherein the silicon spacer is adjacent to the insulated conductor.

13. The cable of claim 11, wherein the conductor comprises two conductors, and wherein the two conductors comprise silicon surrounding and coupling the two conductors.

14. The cable of claim 11, wherein the conductor comprises at least one gap that comprises the air channel.

15. The cable of claim 11, wherein the insulator comprises at least one gap that comprises the air channel.

16. The cable of claim 11, further comprising:
at least one air tube, wherein the at least one air tube is located adjacent to the insulated conductor and comprises the air channel.

17. The cable of claim 16, wherein the at least one air tube comprises an aluminum air tube.

18. The cable of claim 16, wherein the insulated conductor and the at least one air tube are cabled.

19. The cable of claim 16, wherein the at least one air tube comprises air flow in one direction.

20. The cable of claim 16, wherein the at least one air tube comprises a first air tube and a second air tube, wherein the first air tube and second air tube comprises air flow in opposite directions.
